(19) United States
(12) Patent Application Publication
(10) Pub. No.: US 2020/0388110 A1
(43) Pub. Date: Dec. 10, 2020

(54) PERSONAL PROGRESSIVE JACKPOT SYSTEM

(71) Applicant: TCS John Huxley Europe Limited, Stoke-On-Trent (GB)

(72) Inventor: Andrew Michael Saunders, London (GB)

(21) Appl. No.: 16/770,206

(22) PCT Filed: Oct. 31, 2018
(86) PCT No.: PCT/GB2018/053150

§ 371 Date: Jun. 5, 2020

(30) Foreign Application Priority Data
Dec. 8, 2017 (GB) 1720534.5

(51) Int. Cl. G07F 17/32

(52) U.S. Cl. CPC G07F 17/3258; G07F 17/3209; G07F 17/3223; G07F 17/3206; G07F 17/3213; G07F 17/3267; G07F 17/3288; G07F 17/3239

(57) ABSTRACT

A personal progressive jackpot system is provided, with the aim of improving player satisfaction. The personal progressive jackpot system comprises, an input member arranged to accept identification information unique to a user, and wager information, the wager information having a wager value. The system further comprises a physical random number generator arranged to generate and output a random number during an operative period; a memory arranged to access and store the identification information, the wager information and the random number, the memory further comprising a personal progressive jackpot value associated with the identification information; a controller arranged to modify the personal progressive jackpot value; and a processor. The processor is arranged to carry out the steps of: link the identification information to a personal progressive jackpot value; calculate a personal progressive jackpot contribution from the wager value; wherein the controller is arranged to increment the personal progressive jackpot value by said personal progressive jackpot contribution; generate a win condition based on the random number; and compare the wager information with the win condition to determine one of: a first outcome, wherein the wagering information satisfies the win condition, and following the first outcome, the controller is arranged to reduce the personalised progressive jackpot value; and a second outcome, wherein the wagering information does not satisfy the win condition; whereby the personal progressive jackpot system provides a personalised gaining experience. In providing a personal progressive jackpot, the present invention allows for a player to contribute solely to their own jackpot total if preferred and reduces the likelihood of player dissatisfaction, which is typically caused by another player winning a jackpot total to which many players contributed.

### FIELD OF THE INVENTION

The present invention relates to personal jackpot systems, and in particular to personal jackpot systems for games comprising a physical random number generator, with the aim of improving player satisfaction.

### BACKGROUND TO THE INVENTION

Currently, players of games comprising physical random number generators are only able to contribute to, and are only eligible for, jackpots which other players can win, such as a community progressive jackpot. Such systems carry a number of limitations, primarily related to dissatisfaction from players having contributed to a community progressive jackpot and having observed (or in some cases not observed) another player reap the benefits of their contribution in the form of a jackpot win.

Community progressive jackpots can lead to a sense of dissatisfaction if a player perceives that they were more deserving of the jackpot prize than the actual winner due to, for instance, having contributed a greater amount to the jackpot total, or having played the game for a longer time-period.

In some such cases, the dissatisfaction is compounded if the current jackpot value is suddenly reset, whereby players cannot see the winner or any fanfare associated with the jackpot being won. This is especially relevant if a jackpot prize is won by someone else in a separate part of a venue. Eventualities such as this can, in some cases, be a cause for players to become suspicious, if a jackpot value is reset without any indication of a normal prize-awarding procedure in operation.

The result in many of the above cases is likely to be player dissatisfaction, and as such, would likely cause reduced interest in games employing such facilities as a community progressive jackpot contribution feature. Ailing player satisfaction would likely lead to a reduced uptake of the particular technology and therefore have a deleterious effect on profit for a particular venue employing such systems.

Current methods of providing a personal jackpot can be found in, for example, U.S. Pat. No. 6,776,715. It is therefore desirable to provide a system which preferably alleviates the ailing satisfaction of players of current physical random number generator systems which require a universal contribution to a community progressive jackpot.

### SUMMARY OF THE INVENTION

In accordance with a first aspect of the present invention there is provided a personal progressive jackpot system comprising, an input member arranged to accept identification information, and wager information, the wager information having a wager value; a physical random number generator arranged to generate and output a random number during an operative period; a memory arranged to access and store the identification information, the wager information and the random number, the memory further comprising a personal progressive jackpot value associated with the identification information; a controller arranged to modify the personal progressive jackpot value; and a processor arranged to carry out the steps of:
link the identification information to a personal progressive jackpot value;
determine a personal progressive jackpot contribution; wherein the controller is arranged to increment the personal progressive jackpot value by said personal progressive jackpot contribution;
generate a win condition based on the random number; and
compare the wager information with the win condition to determine one of:
   a first outcome, wherein the wagering information satisfies the win condition, and following the first outcome, the controller is arranged to reduce the personalised progressive jackpot value; and a second outcome, wherein the wagering information does not satisfy the win condition;
      whereby the personal progressive jackpot system provides a personalised gaming experience.

The personal progressive jackpot system of the present invention preferably provides a personal progressive jackpot value for each individual player. The personal progressive jackpot value is associated with the player by way of unique identification information and as such can preferably be transferred across multiple games, and may be transferred across multiple tables and multiple venues depending upon local regulations and restrictions.

Methods of the currently available technology are employed solely for use in relation to video games and carry a number of limitations.

The identification information, unique to a user, is input via the input member and is either recognised by the system according to a previously stored personal progressive jackpot value associated with said information located on the memory, or a personal progressive jackpot value is generated and associated to the identification information. The system comprises a physical random number generator, on which the player may submit wager information via the input member.

The controller is preferably further arranged to reduce the personal progressive jackpot value following an additional outcome unrelated to the physical random number generator. In such embodiments, the additional outcome preferably results from a random event.

In most preferable embodiments, the personal progressive jackpot system preferably comprises an option for submitting side-wager information comprising a side-wager value. In such embodiments, the side-wager value may influence the determination of the personal progressive jackpot contribution.

In some embodiments, the system further comprises an additional jackpot value. In such embodiments, the additional jackpot value is preferably one selected from the range: community progressive jackpot; linked progressive jackpot; mystery jackpot; flat jackpot; independent jackpot; standalone jackpot; proprietary progressive jackpot; wide progressive jackpot.

In such embodiments, the additional jackpot value may be unrelated to the personal progressive jackpot value.

The personal progressive jackpot contribution preferably comprises value according to at least one selected from the range: a value dependent upon the wager value; a value independent of the wager value.

The processor is arranged to determine a personal progressive jackpot contribution, wherein the controller is arranged to increment the personal progressive jackpot value by the personal progressive jackpot contribution. The wager information comprises a wager value, which is preferably used by the processor to calculate or determine the personal progressive jackpot contribution. In preferable embodiments, the processor calculates the personal progressive jackpot contribution according to a percentage of the wager value.

In some embodiments, the personal progressive jackpot contribution, determined by the processor, is a fixed amount, and may be unrelated to the wager value.

In most preferable embodiments of the personal progressive jackpot system according to the first aspect of the present invention, the controller is further arranged to transmit currency according to the personal progressive jackpot value to said user. In such embodiments, said transmission of currency is performed following the first outcome, and prior to the reduction of the personal progressive jackpot value.

The system preferably further comprises a player tracking member arranged to store wager information in the memory, and further arranged to associate said stored wager information to the identification information.

Following the first outcome, the controller preferably reduces the personalised progressive jackpot value to a predetermined minimum value. The predetermined minimum value is preferably no value.

The predetermined minimum value is preferably a starting-point from which the personal progressive jackpot value is preferably built upon following successive games resulting in the second outcome, before the eventuality of the first outcome following which the personal progressive jackpot value is preferably transmitted to the player and the stored personal progressive jackpot value is subsequently reduced by the controller, preferably to no value.

The input member preferably comprises a display screen arranged to display options for inputting wager information. The display screen is preferably arranged to display a jackpot message following the first outcome. In embodiments wherein the input member comprises a display screen, the system preferably further comprises an imaging member arranged to image the physical random number generator and provide said image to the display screen, wherein the display screen is further arranged to display the image.

In preferable embodiments, the input member is operated remotely to the physical random number generator and as such a visual confirmation of the result of the physical random number generator is preferably provided to the player by way of a display screen comprised within the input member. The display screen preferably provides the player with wagering options, which the player will preferably use to input wagering information into the input member. In most preferable embodiments, the player is provided with a video feed of the physical random number generator by way of the display screen and as such is preferably provided with real-time feedback of the generated random number. In embodiments comprising a display screen, the display screen most preferably provides a visual message to the player following the first outcome.

The system preferably further comprises a server, wherein the server comprises at least one selected from: the processor, the memory, the controller. In embodiment comprising a server, the server is preferably wireless enabled. In the context of the present invention, wireless enabled refers to an ability to send and/or receive communication and/or data transmitted wirelessly.

The use of a server preferably allows for a single system to operate many physical random number generators and input members, and as such can preferably accommodate for any number of players, each having unique identification information and a unique personal progressive jackpot value. Wireless communication between the server and the input members and the physical random number generators preferably provides flexibility to the system, preferably allowing for easier maneuverability of equipment, or alternatively addition or removal of input members and physical random number generators. Passing communication through the server also preferably provides players operating the input members with the feature of selecting a physical random number generator, and therefore a game to play. This preferably provides the advantage of having players be able to choose a game on which to submit wager information, without having to change input member. The use of a centralised server also preferably provides for improved cross-compatibility across different games and added security.

The personal progressive jackpot contribution preferably comprises currency obtained from at least one selected from the range: the wager value; an owner of the system.

In accordance with most preferable embodiments, the personal progressive jackpot contribution is preferably provided only in-part by currency input from the player, with the remainder of the personal progressive jackpot contribution preferably provided by the owner of the system, such as from a marketing fund, and with the intention of drawing more players to the system promising higher jackpot values than jackpot systems accepting only contributions from currency provided by the players.

The physical random number generator is preferably one selected from the range: roulette wheel; dice shaker; dice spinner; number wheel; money wheel; sic bo; playing cards; electronic card shoe; manual card shoe; bingo machine; lottery machine.

The memory preferably comprises a time-limit associated with the identification information, the time-limit defining a fixed period of time after which the controller is arranged to reduce the personal progressive jackpot value. Preferably the time-limit defines a fixed period of time from the most recent input of the identification information. In preferable embodiments the input member comprises a logout function arranged to be activated upon request by a user. In embodiments wherein the input member comprises a logout function, the time-limit preferably defines a fixed period of time from the most recent activation of the logout function.

Upon reaching the time-limit, the controller preferably reduces the personal progressive jackpot value to a predetermined minimum value. The predetermined minimum value is preferably no value.

The system of the present invention preferably comprises a “time-bomb” feature, whereupon passage of a predetermined amount of time since either input of identification information to the input member (e.g. player login) or exit of a player from the input member (e.g. player logout) causes the personal progressive jackpot value associated with said identification information to be reduced, preferably to a predetermined value of no value.

The input member preferably comprises a personal identification device arranged to input the identification information. The personal identification device preferably comprises at least one selected from the range: a touch screen; a number pad; an electronic chip reader; a card reader; a fingerprint scanner; a retinal scanner; a voice recognition device; a contactless data transfer member.

In accordance with a second aspect of the present invention, a method of providing a personal progressive jackpot is provided, the method comprising the steps of:
identifying a user and accessing user-associated information including a personal progressive jackpot value;
operating a physical random number generator to generate a random number;
accepting wager information based on the physical random number generator, the wager information comprising a wager value;
calculating a personal progressive jackpot contribution;
incrementing the personal progressive jackpot value by the personal progressive jackpot contribution;
determining a win condition;
comparing the wager information with the win condition; and
if the wager information satisfies the win condition, reducing the personal progressive jackpot value.

The method of the second aspect of the present invention is preferably carried out using a system according to the first aspect of the present invention.

In accordance with a third aspect of the present invention, there is provided a computer program product including a program for a processing device, comprising software code portions for performing the steps of a method according to the second aspect of the present invention when the program is run on the processing device.

Preferably the computer program product comprises a computer-readable medium on which the software code portions are stored, wherein the program is directly loadable into an internal memory of the processing device.

Preferably the processing device is comprised within a personal progressive jackpot system according to the first aspect of the present invention.

### DETAILED DESCRIPTION

Specific embodiments will now be described by way of example only, and with reference to the accompanying drawings, in which:

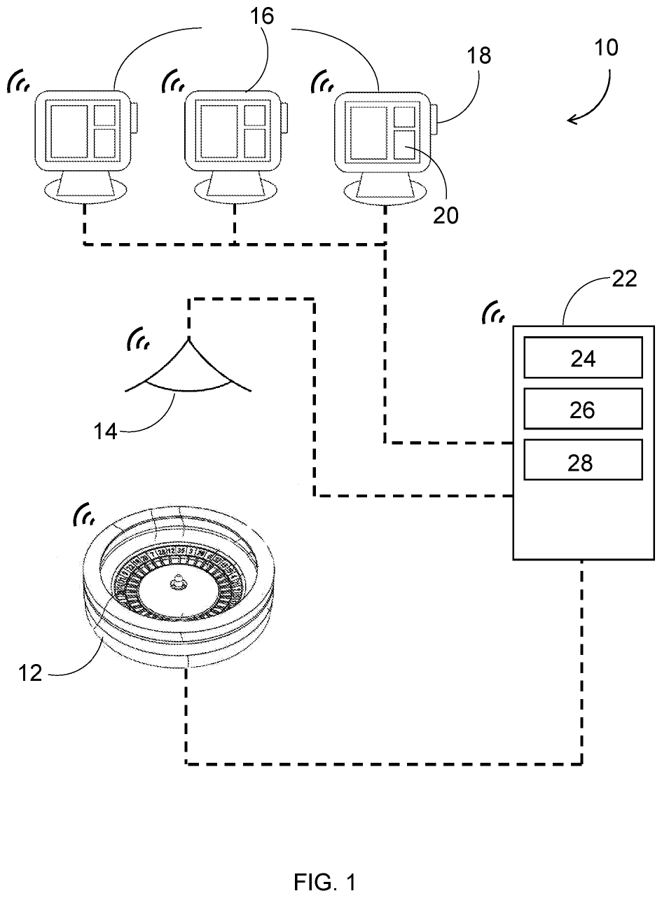

FIG. 1 provides a schematic diagram of an embodiment of a personal progressive jackpot system according to the first aspect of the present invention; and

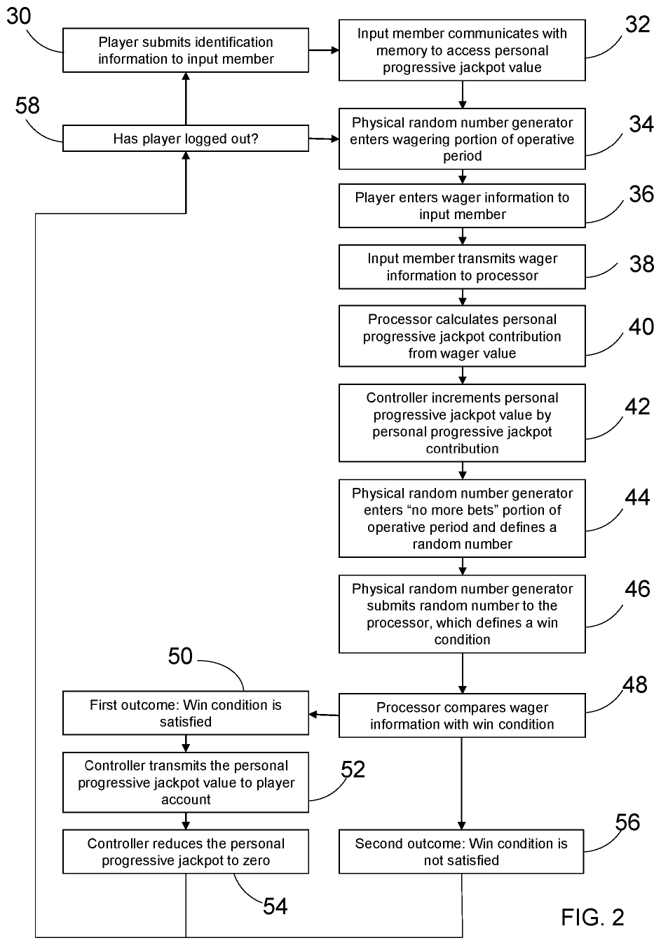

FIG. 2 provides a flow chart of example steps of a method of providing a personal progressive jackpot according to the second aspect of the present.

Referring to FIG. 1 a personal progressive jackpot system 10 is provided comprising a physical random number generator 12, which in the example embodiment shown takes the form of a roulette wheel providing a plurality of wagering options. The roulette wheel 12 has an operative period during which a random number is selected. An imaging member 14 is located substantially above the roulette wheel 12, the imaging member 14 taking the form of a wireless camera. The wireless camera 14 provides a plan view of the roulette wheel 12 to a plurality of input members 16, which are situated remote to the roulette wheel 12, said input members 16 comprising a personal identification device 18 and a display screen 20 which is touch-sensitive. A server 22 is located remotely to the roulette wheel 12 and the touch screen devices 16, and is in wireless communication with said roulette wheel 12 and the touch screen devices 16. The server comprises a memory 24 in digital communication with a processor 26 and a controller 28, the controller 28 further being in digital communication with the processor 26.

In use, a user actuates the personal identification device 18, which in the embodiment shown is a contactless card reader positioned on the touch screen device 16. The card reader 18 is actuated by placing a personal identification card (not shown) within sufficient proximity for identification information located on said card to be read by the card reader 18. Following said input of identification information into the touch screen device 16, said identification information is transmitted wirelessly to the server 22, and stored in the memory 24. The processor 26 identifies the identification details and disables a time-limit feature associated with said identification details, if one is present. The processor 26 further identifies a personal progressive jackpot value stored on the memory 24 which is associated with the identification information.

The display screen is arranged to display an image of the roulette wheel 12, accessed from the wireless camera 14 via the server 22. During the operative period of the roulette wheel 12, a user may submit wager information during a betting portion of said operative period by selecting from the available wagering options for the roulette wheel 12 displayed on the touch-sensitive display screen 20 of the touch screen device 16. The operative period of the roulette wheel 12 also comprises a “no more bets” period, during which wager information cannot be input into the touch screen device 16. When input, wager information is transmitted wirelessly to the server 22, where the wager information, having a wager value, is stored in the memory 24. The processor 26 calculates a personal progressive jackpot contribution, which in the embodiment shown is a percentage of the wager value.

The personal progressive jackpot contribution is used by the controller 28 to increment the personal progressive jackpot value associated with the identification information and stored in the memory 24. At the end of the operative period of the roulette wheel 12, a random number is generated and communicated to the server 22. The processor 26 uses the random number to generate a win condition, which is subsequently compared by the processor 26 to the wager information.

If the wager information satisfies the win condition, a first outcome is followed in which the controller 28 arranges the transmission of currency equal to the personal progressive jackpot total to the user (not shown), following which the controller 28 reduces the personal progressive jackpot value to zero. In the embodiment shown, during the first outcome, a message is displayed to the user via the display screen of the touch screen device 16, indicating to the user that the personal progressive jackpot has been won.

If the wager information does not satisfy the win condition, the display screen of the touch screen device 16 is arranged to display a message to the user indicating that the personal progressive jackpot has not been won.

If at any point the user decides to leave the touch screen device 16, they may elect to “log out”, and as such the personal progressive jackpot value is stored in the memory and a predetermined time-limit is associated with the identification information. If the time-limit is reached prior to the next time the same identification information is input into an input member of the system, the personal progressive jackpot value associated with said identification information is reduced to zero.

A method according to the second aspect of the present invention can be seen from the flowchart of FIG. 2. The embodiment of the method shown preferably utilises a personal progressive jackpot system according to the first aspect of the present invention, such as the embodiment previously described and shown in FIG. 1.

The method shown comprises the steps of:
identifying a user and accessing user-associated information including a personal progressive jackpot value 30, 32;
operating a physical random number generator to generate a random number 34, 44;
accepting wager information based on the physical random number generator, the wager information comprising a wager value 36, 38;
calculating a personal progressive jackpot contribution 40;
incrementing the personal progressive jackpot value by the personal progressive jackpot contribution 42;
determining a win condition 46;
comparing the wager information with the win condition 48; and
if the wager information satisfies the win condition, reducing the personal progressive jackpot value 50, 52, 54.

If the wager information does not satisfy the win condition, a second outcome is followed wherein the personal progressive jackpot value is not reduced 56. Following the method according to the embodiment shown, the system detects whether the user wishes to continue into the next operative period of the physical random number generator, according to whether the user has selected to log out 58. Depending on whether the user has selected to log out, the method may follow the steps of continuing to operate a physical random number generator, to generate a random number 34, or to wait and identify a new user 30.

The third aspect of the present invention comprises a computer program product including a program for a processing device, comprising software code portions for performing the steps of the method of the embodiment shown when the program is run on the processing device. The computer program product comprises a computer-readable medium on which the software code portions are stored, wherein the program is directly loadable into an internal memory of the processing device. In the embodiment shown, the processing device is the server 22 comprising the processor 26 and internal memory 24.

It will be appreciated that the above described embodiments are given by way of example only and that various modifications may be made thereto without departing from the scope of the invention as defined in the appended claims. For example, the described embodiments use the features of the present invention in an automated system, whereas embodiments will be conceivable wherein features of the invention are carried out manually, whilst remaining within the scope of the present disclosure. For instance, automatic input of identification information is discussed, whereas embodiments are available wherein the identification is input manually. The controller is discussed as being a part of a server, whereas the controller may be a person operating the system of the present invention. The time-limit feature is discussed as defining a time period between a “log-out” and a “log-in” event. Embodiments may provide a time-limit feature that defines a time period between a “log-in” and a “log-out” event.

1. A personal progressive jackpot system comprising,
an input member arranged to accept identification information unique to a user, and wager information, the wager information having a wager value;
a physical random number generator arranged to generate and output a random number during an operative period;
a memory arranged to access and store the identification information, the wager information and the random number, the memory further comprising a personal progressive jackpot value associated with the identification information;
a controller arranged to modify the personal progressive jackpot value; and
a processor arranged to:
link the identification information to the personal progressive jackpot value;
calculate a personal progressive jackpot contribution; wherein the controller is arranged to increment the personal progressive jackpot value by the personal progressive jackpot contribution;
generate a win condition based on the random number; and
compare the wager information with the win condition to determine one of:
a first outcome, wherein the wagering information satisfies the win condition, wherein following the first outcome, the controller is arranged to reduce the personalised progressive jackpot value; and
a second outcome, wherein the wagering information does not satisfy the win condition;
whereby the personal progressive jackpot system provides a personalised gaming experience.

2. The personal progressive jackpot system of claim 1, wherein the controller is further arranged to reduce the personal progressive jackpot value following an additional outcome unrelated to the physical random number generator.

3. The personal progressive jackpot system of claim 2, wherein the additional outcome results from a random event.

4. The personal progressive jackpot system of claim 1, further comprising an additional jackpot value.

5. The personal progressive jackpot system of claim 4, wherein the additional jackpot value is selected from the range:
a community progressive jackpot;
a linked progressive jackpot;
a mystery jackpot;
a flat jackpot;
an independent jackpot;
a standalone jackpot;
a proprietary progressive jackpot; and
a wide progressive jackpot.

6. The personal progressive jackpot system of claim 1, wherein the personal progressive jackpot contribution comprises value according to at least one selected from the range: a value dependent upon the wager value; a value independent of the wager value.

7. The personal progressive jackpot system of claim 1, wherein the controller is further arranged to transmit currency according to the personal progressive jackpot value to the user.

8. The personal progressive jackpot system of claim 7, wherein the transmission of currency is performed following the first outcome, and prior to the reduction of the personal progressive jackpot value.

9. The personal progressive jackpot system of claim 1, wherein the system further comprises a player tracking member arranged to store wager information in the memory, and further arranged to associate the stored wager information to the identification information.

10. The personal progressive jackpot system of claim 1, wherein following the first outcome, the controller reduces the personalized progressive jackpot value to a predetermined minimum value.

11. The personal progressive jackpot system of claim 1, wherein the input member comprises a display screen arranged to display options for inputting wager information.

12. The personal progressive jackpot system of claim 11, wherein the display screen is arranged to display a jackpot message following the first outcome.

13. The personal progressive jackpot system of claim 11, wherein the system further comprises an imaging member arranged to image the physical random number generator and provide the image to the display screen, wherein the display screen is further arranged to display the image.

14. The personal progressive jackpot system of claim 1, further comprising a server, wherein the server comprises at least one selected from: the processor, the memory, the controller.

15. The personal progressive jackpot system of claim 14, wherein the server is wireless enabled.

16. The personal progressive jackpot system of claim 1, wherein the personal progressive jackpot contribution comprises currency obtained from at least one selected from the range: the wager value; an owner of the system.

17. The personal progressive jackpot system of claim 1, wherein the physical random number generator is one selected from the range:
a roulette wheel;
a dice shaker;
a dice spinner;
a number wheel;
a money wheel;
sic bo;
playing cards;
an electronic card shoe;
a manual card shoe;
a bingo machine; or
a lottery machine.

18. The personal progressive jackpot system of claim 1, wherein the memory comprises a time-limit associated with the identification information; wherein the time-limit defines a fixed period of time after which the controller is arranged to reduce the personal progressive jackpot value.

19. The personal progressive jackpot system of claim 18, wherein the time-limit defines a fixed period of time from the most recent input of the identification information.

20. The personal progressive jackpot system of claim 18, wherein the input member comprises a logout function arranged to be activated upon request by the user, and wherein the time-limit defines a fixed period of time from the most recent activation of the logout function.

21. The personal progressive jackpot system of claim 18, wherein upon reaching the time-limit, the controller reduces the personal progressive jackpot value to a predetermined minimum value.

22. The personal progressive jackpot system of claim 1, wherein the input member comprises a personal identification device arranged to input the identification information.

23. The personal progressive jackpot system of claim 22, wherein the personal identification device comprises at least one selected from the range:
a touch screen;
a number pad;
an electronic chip reader;
a card reader;
a fingerprint scanner;
a retinal scanner;
a voice recognition device; or
a contactless data transfer member.

24. A method of providing a personal progressive jackpot comprising:
identifying a user and accessing user-associated information including a personal progressive jackpot value;
operating a physical random number generator to generate a random number;
accepting wager information based on the physical random number generator, the wager information comprising a wager value;
calculating a personal progressive jackpot contribution;
incrementing the personal progressive jackpot value by the personal progressive jackpot contribution;
determining a win condition;
comparing the wager information with the win condition; and
if the wager information satisfies the win condition, reducing the personal progressive jackpot value.

25. (canceled)

26. A computer-readable storage medium storing instructions that cause a processor to:
identify a user and access user-associated information including a personal progressive jackpot value;
operate a physical random number generator to generate a random number;
accept wager information based on the physical random number generator, the wager information comprising a wager value;
calculate a personal progressive jackpot contribution;
increment the personal progressive jackpot value by the personal progressive jackpot contribution;
determine a win condition;
compare the wager information with the win condition; and
if the wager information satisfies the win condition, reduce the personal progressive jackpot value.

27. (canceled)
